(19) United States
(12) Patent Application Publication
(10) Pub. No.: US 2004/0100571 A1
(43) Pub. Date: May 27, 2004

(54) System and method for communicating information in an image capture device

(76) Inventor: Kurt E. Spears, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/301,157

(22) Filed: Nov. 21, 2002

(51) Int. Cl. H04N 5/335

(52) U.S. Cl. 348/273

(57) ABSTRACT

An embodiment of the present invention communicates information within an image capture device by communicating information from a first plurality of pixels sensitive to a first color of light along a first path, and concurrently communicating information from a portion of a second plurality of pixels sensitive to a second color of light along a second path; and communicating information from a third plurality of pixels sensitive to a third color of light along the first path, and concurrently communicating information from a remaining portion of the second plurality of pixels sensitive to the second color of light along the second path.

### BACKGROUND OF THE INVENTION

1. Field of the Invention

The present invention generally relates to digital image capture devices and, in particular, to a system and method for communicating information in an image capture device.

2. Related Art

With the advent of digitally-based image capture devices capable of “photographing” an image and providing the image in a digital data format, a digital “photograph” of the image is stored in a memory residing within or coupled to the image capture device. Nonlimiting examples of a digital image capture device are digital cameras that capture still images and/or video images, scanners and copy machines.

Digital image capture devices typically employ light detecting devices comprising a large numbers of pixels. Pixels accumulate charge corresponding to the amount of detected light (and color if the pixel is color-sensitive). When charges are accumulated at pixels and communicated by registers, the array of pixels and registers is referred to herein as a charge-coupled device (CCD). Pixels sensitive to selected colors are arranged in a large matrix. Color-sensitive pixels are dispersed across the matrix in a predefined pattern so that all regions of the matrix are color-sensitive. Some embodiments of a digital image capture device employ a CCD having in excess of three million pixels.

When the digital image capture device is capturing video images, typically there is not sufficient time available per image frame for the processing of all of the pixels, particularly if a CCD having several million pixels is used to capture images. Accordingly, selected pixels are sampled for light information. The light information from the sampled pixels is used to construct the captured image. More expensive and complex digital image capture devices are able to sample a greater number of pixels within the time period for a single frame because faster components with greater bandwidth are used. However, image quality is sacrificed with any form of pixel sampling because light information from the pixels that are not sampled is simply discarded, e.g., artifacts may be apparent when the captured image is displayed or otherwise reproduced. Also, color variations in the captured image, not present in the image itself, may be visible.

Alternatively, other embodiments digitally-average light information from groupings of pixels to improve image quality. However, such averaging requires time and computational capacity since the light information is received from all of the pixels and then digitally averaged by a processor. When capturing videos, such averaging of the light information is limited because the averaging for each selected group of pixels must occur within the time allocated for one image frame of a video. Furthermore, some artifacts and some color variation may still be visible. Averaging light information requires a much higher bandwidth and processing capacity, and results in less-than-optimal noise performance, thereby sacrificing image quality.

Also, it may be desirable to save still digital images with less resolution, thereby saving memory capacity. For example, a digital image capture device having three million pixels utilizes a substantial portion of the digital image capture device's memory to store a high quality image when light information from every individual pixel is saved. Accordingly, pixel sampling allows for a lower resolution image to be captured and stored in the memory, thereby requiring significantly less memory capacity. Alternatively, averaging light information from groupings of pixels can be employed to save memory capacity. However, as noted before, image quality is sacrificed with pixel sampling because light information from the pixels that are not sampled is simply discarded. Similarly, averaging light information requires a much higher bandwidth and processing capacity, and results in less than optimal noise performance, thereby sacrificing image quality.

When image information is retrieved from the pixels, the light information is amplified so that downstream components may better receive and process the image information. When color information is amplified, an amplifier is selected that is configured to amplify the colors of light detected by the pixels. For example, if a CCD device employs a plurality of pixels wherein a pixel is sensitive to either red, green or blue light, the amplifier is configured to amplify light information corresponding to red, green and blue light. However, such an amplifier is not as efficient and/or effective as amplifiers configured to amplify light information corresponding to specific colors of light.

### SUMMARY

Generally, an embodiment of the present invention communicates information within an image capture device by communicating information from a first plurality of pixels sensitive to a first color of light along a first path, and concurrently communicating information from a portion of a second plurality of pixels sensitive to a second color of light along a second path; and communicating information from a third plurality of pixels sensitive to a third color of light along the first path, and concurrently communicating information from a remaining portion of the second plurality of pixels sensitive to the second color of light along the second path.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1A is a block diagram illustrating an image capture device employing an embodiment of a charge-coupled device (CCD) according to the present invention.

FIG. 1B is a block diagram illustrating an embodiment of a portion of a CCD according to the present invention.

FIGS. 2A-2F are block diagrams illustrating an embodiment of a system to communicate red and green light information from selected pixels from a portion of a CCD according to the present invention.

FIGS. 3A-3F are block diagrams illustrating an embodiment of a system to communicate blue and green light information from selected pixels from a portion of a CCD according to the present invention.

FIG. 4 is a flow chart illustrating an embodiment of a process, according to the present invention, for communicating light information.

FIGS. 5A-5F are block diagrams illustrating an embodiment of a system to communicate light information from a CCD according to the present invention.

FIG. 6 is a flow chart illustrating an embodiment of a process, according to the present invention, for communicating light information from a CCD.

### DETAILED DESCRIPTION

In general, the present invention relates to communicating information corresponding to a captured image captured by a digital image capture device, such as, but not limited to, a digital camera that captures still and/or video images, a scanner, a facsimile machine or a copy machine. The present invention is applicable to any digitally-based image capture device that employs a matrix of pixels to sense light. For convenience, one embodiment of the present invention is described as being implemented in, or being part of, a digital camera 10 configured to capture still images and/or video images. As used herein, the phrase “captured image” refers to a captured digital still image and/or a captured video image.

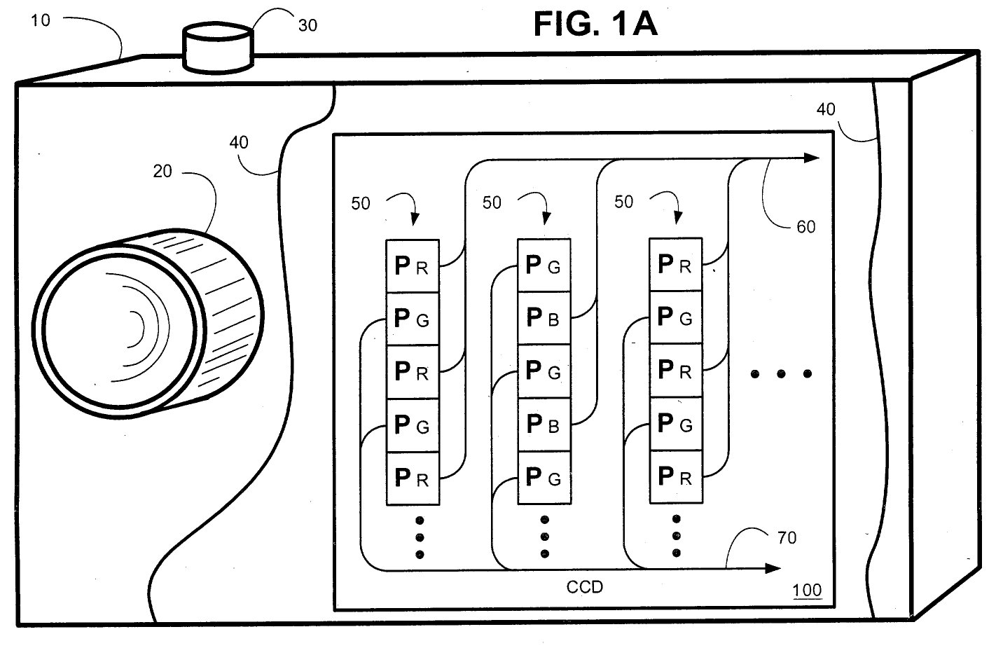

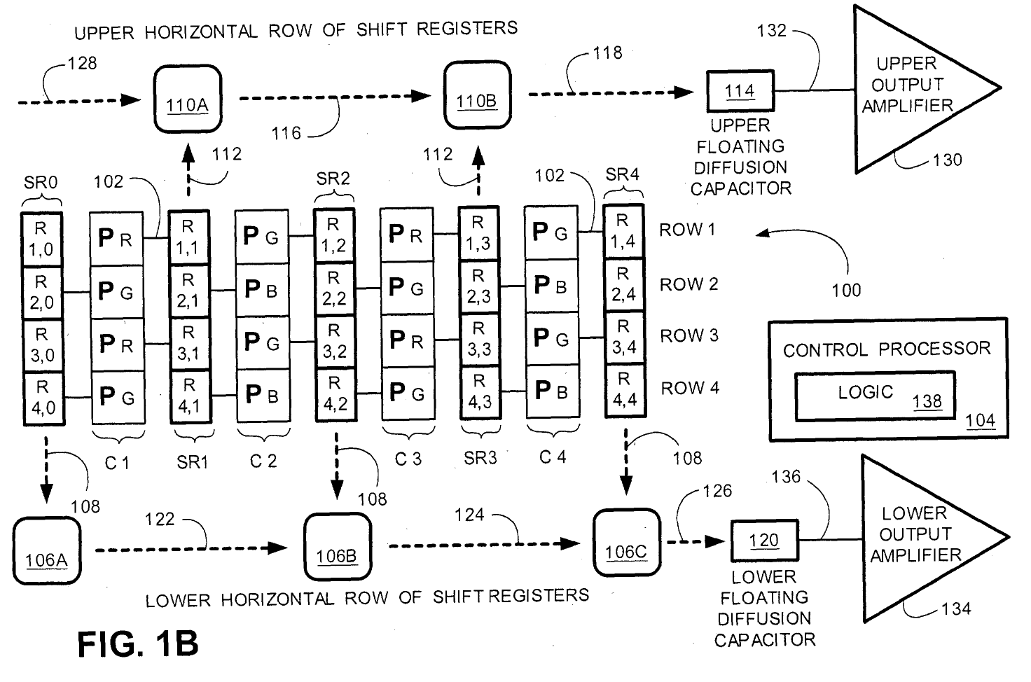

FIG. 1A is a block diagram illustrating an image capture device 10 employing an embodiment of a CCD 100 according to the present invention. Digital camera 10 further includes at least a lens unit 20 and an image capture actuation button 30. Selected external and internal components of the digital camera 10 are demarked by cut-away lines 40. Thus, CCD 100 is an internal component, and lens unit 20 and image capture actuation button 30 are external components.

The exemplary embodiment of CCD 100 further comprises a plurality of columns of pixels 50. Alternating columns of pixels are comprised of a plurality of pixels sensitive to red light [red pixels (PR)] and a plurality of pixels sensitive to green light [green pixels (PG)]. Adjacent columns are comprised of a plurality of pixels sensitive to blue light [blue pixels (PB)] and a plurality of pixels sensitive to green light [green pixels (PG)].

CCD 100 is disposed in a suitable location behind lens unit 20 such that an image may be focused onto CCD 100 for capturing. When the operator has focused the image to be captured and is satisfied with the focused image, the operator actuates the image capture actuation button 30 (also referred to as a shutter button or a shutter release button) to cause digital camera 10 to capture the image, thus “photographing” the image. CCD 100 detects the image through lens unit 20. Pixels residing in the CCD 100 accumulate charge corresponding to a quantifiable value indicative of the luminous intensity of a given color of light received from the image. The quantifiable values from the pixels, referred to herein as “light information” for convenience, are communicated to other components of digital camera 10 for processing over the two paths described hereinafter.

In accordance with the present invention, light information from the red pixels (PR) and blue pixels (PB) is communicated along a first path 60 through CCD 100. Light information from the green pixels (PG) is communicated along a second path 70 through CCD 100. The process of communicating light information from the pixels along the two paths 60 and 70 is described below.

FIG. 1B is a block diagram illustrating an embodiment of a portion of CCD 100 according to the present invention. For convenience, a pixel matrix size is defined in FIG. 1B as a 4×4 matrix, illustrated by a row of pixels four pixels wide and a column of pixels four pixels deep. It is understood that any suitable pixel matrix size can be defined based upon the desired resolution of the captured image.

The portion of CCD 100 illustrated in FIG. 1B comprises at least a plurality of red pixels (PR), a plurality of blue pixels (PB) and a plurality of green pixels (PG). In one embodiment, red pixels (PR) alternate with green pixels (PG) along a pixel row. For example, the portion of the CCD 100 illustrates the first row and the third row as having alternating red pixels (PR) and green pixels (PG). Thus, every other row of pixels in the CCD 100 are configured with alternating red pixels (PR) and green pixels (PG).

Similarly, blue pixels (PB) alternate with green pixels (PG) along the remaining pixel rows. For example, the portion of the CCD 100 illustrates the second row and the fourth row as having alternating blue pixels (PB) and green pixels (PG). Thus, every other row of pixels in the CCD 100 are configured with alternating blue pixels (PB) and green pixels (PG).

Furthermore, since the red pixels (PR), the blue pixels (PB) and the green pixels (PG) are configured in a matrix, the pixels may be viewed as comprising adjacent columns of pixels. Columns of pixels are referenced as columns C1 through C4 in FIG. 1B.

In this embodiment of the CCD 100, twice as many green pixels (PG) are employed as either red pixels (PR) or blue pixels (PB). Accordingly, the CCD 100 is more sensitive to, and has a higher sampling rate for, green light. Other embodiments of CCDs according to the present invention employ different numbers of, and different positioning schemes, for red pixels (PR), blue pixels (PB) and/or green pixels (PG).

Adjacent to each one of the pixels is a shift register. These shift registers in FIG. 1B are oriented in columns and, for convenience of illustration, are labeled as SR0 through SR4. Accordingly, any individual shift register is identifiable by its column designation and its row designation. For example, the upper right-hand corner shift register is designated as “R1,4” in FIG. 1B. In actual implementation, the location of the shift registers in the CCD 100 may be identified using any suitable identification system.

Each shift register is in communication with pixels to which the register is coupled, via a connection 102. For example, the R1,4 shift register is in communication with a green pixel (PG). Accordingly, in response to a suitable control signal provided by a control processor (104) controlling flow of light information through and from the CCD 100, the shift register R1,4 receives light information from its adjacent green pixel (PG). Control processor 104 is communicatively coupled with the shift registers and other components described below.

Shift registers in a column are in serial communication with an adjacent shift register. The column of shift registers SR0, SR2 and SR4 communicate light information from the green pixels (PG) in a path as indicated according to the embodiment illustrated. For example, the shift register R2,0 receives light information from its respective green pixel (PG). Upon receiving a suitable control signal from control processor 104, light information is serially communicated from shift register R2,0 to shift register R3,0. The light information is eventually communicated to the lower horizontal shift register 106A, according to the present invention as described below. For convenience of illustration, the direction of flow of light information for the green pixels (PG) through the columns of shift registers SR0, SR2 and SR4 are denoted by the downward-pointed dashed-arrow lines 108. Shift registers 106A-106C comprise a portion of a lower horizontal row of shift registers in communication with each other and in communication with the shift register immediately above it.

Similarly, the columns of shift registers SR1 and SR3 communicate light information from the red pixels (PR) and the blue pixels (PB). Light information is communicated in another path according to the present invention. For example, the shift register R1,1 receives light information from its respective red pixel (PR). Upon receiving a suitable control signal from control processor 104, light information is communicated in a path as indicated from shift register R1,1 to the upper horizontal shift register 110A, according to the embodiment illustrated. For convenience of illustration, the path of flow of light information from the red pixels (PR) or the blue pixels (PB) through the columns of shift registers SR1 and SR3 are denoted by the upward-pointed dashed-arrow lines 112. Shift registers 110A-110B comprise a portion of an upper horizontal row of shift registers.

Suitable control signals are communicated from the control processor 104 to the above-described shift registers. In one embodiment, logic 138 is executed by the control processor 104 to determine the suitable control signals. These control signals, referred to hereinafter as clocking signals and/or clock signals, prompt the communication of light information through the shift registers and the diffusion capacitors. Any suitable clock signal may be employed in accordance with the present invention, and is therefore not described in detail herein for convenience and for brevity.

For convenience of illustrating the portion of a charge-coupled device (CCD) 100 in FIG. 1B, only a relatively small portion of the CCD 100 is illustrated in FIG. 1B (i.e., sixteen pixels and a portion of five columns of shift registers). Also for convenience of illustrating, connection between shift registers are omitted in FIG. 1B. It is understood that the systems and methods of present invention are applicable to all pixels and shift registers in CCD 100. Thus, the present invention is configured to communicate light information in a CCD 100 having thousands, even millions, of pixels. Although FIG. 1B illustrates only four pixels in a column, for convenience, the present invention is configured to communicate light information from a CCD 100 having many pixels in a column.

The shift registers 110A-110B of the upper horizontal row are serially communicatively connected and configured to serially communicate light information to the upper floating diffusion capacitor 114. For example, shift register 110A is in communication with shift register 110B, as denoted by the dashed-arrow line 116. Similarly, shift register 110B is in communication with the upper floating diffusion capacitor 114, as denoted by the dashed-arrow line 118. Thus, the upper floating diffusion capacitor 114 is communicatively coupled to the last serially-connected shift register of the upper horizontal row of shift registers.

Similarly, the shift registers 106A-106C of the lower horizontal row are serially communicatively connected and configured to serially communicate light information to the lower floating diffusion capacitor 120. For example, shift register 106A is in communication with shift register 106B, as denoted by the dashed-arrow line 122. Similarly, shift register 106B is in communication with shift register 106C, as denoted by the dashed-arrow line 124. Shift register 110C is in communication with the lower floating diffusion capacitor 120, as denoted by the dashed-arrow line 126. Thus, the lower floating diffusion capacitor 120 is communicatively coupled to the last one of the serially-connected shift register of the lower horizontal row of shift registers.

For convenience, CCD 100 illustrates only relatively small portions of the upper and lower horizontal rows of shift registers. The present invention communicates light information as described herein through all of the upper and lower horizontal row shift registers in CCD 100. Thus, light information is serially communicated to the upper floating diffusion capacitor 114 through the upper horizontal rows of shift registers having hundreds, even thousands, of shift registers. Light information is serially communicated to the lower floating diffusion capacitor 120 through the lower horizontal rows of shift registers

In accordance with the present invention, light information is accumulated in the upper floating diffusion capacitor 114. Upon receiving a suitable control signal from control processor 104, the accumulated light information in the upper floating diffusion capacitor 114 is communicated to the upper output amplifier 130, via connection 132, for amplification and communication to other components residing in the digital image capture device. Similarly, light information is accumulated in the lower floating diffusion capacitor 120. Upon receiving a suitable control signal from control processor 104, the accumulated light information in the lower floating diffusion capacitor 120 is communicated to the lower output amplifier 134, via connection 136, for amplification and communication to other components residing in the digital image capture device.

According to an embodiment of the present invention, the upper output amplifier 130 is configured to amplify and communicate red and blue light information. The lower output amplifier 134 is configured to amplify and communicate green light information.

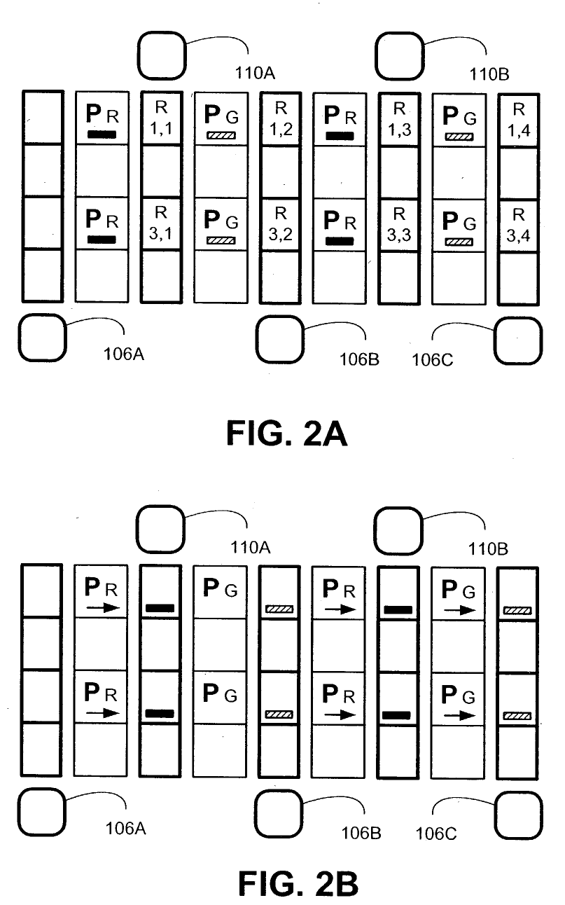

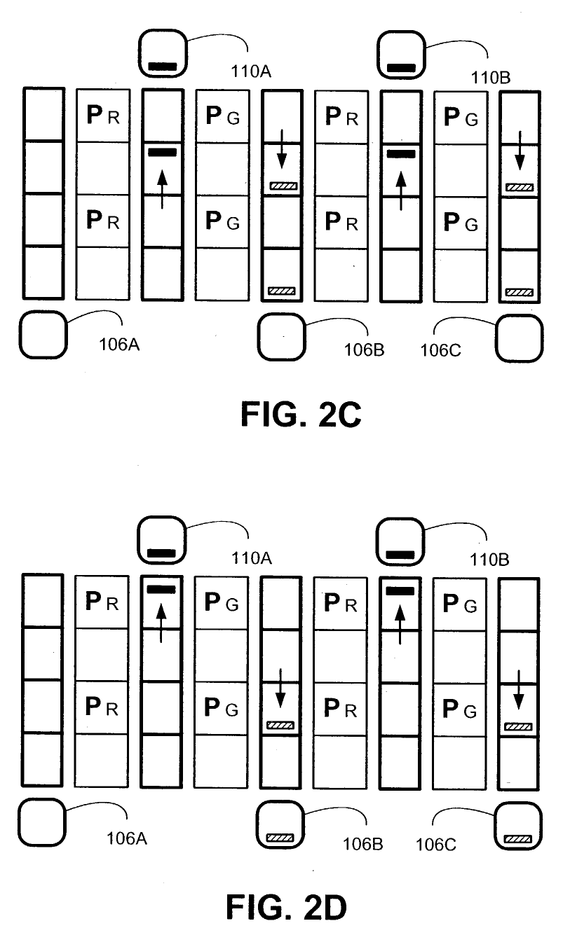

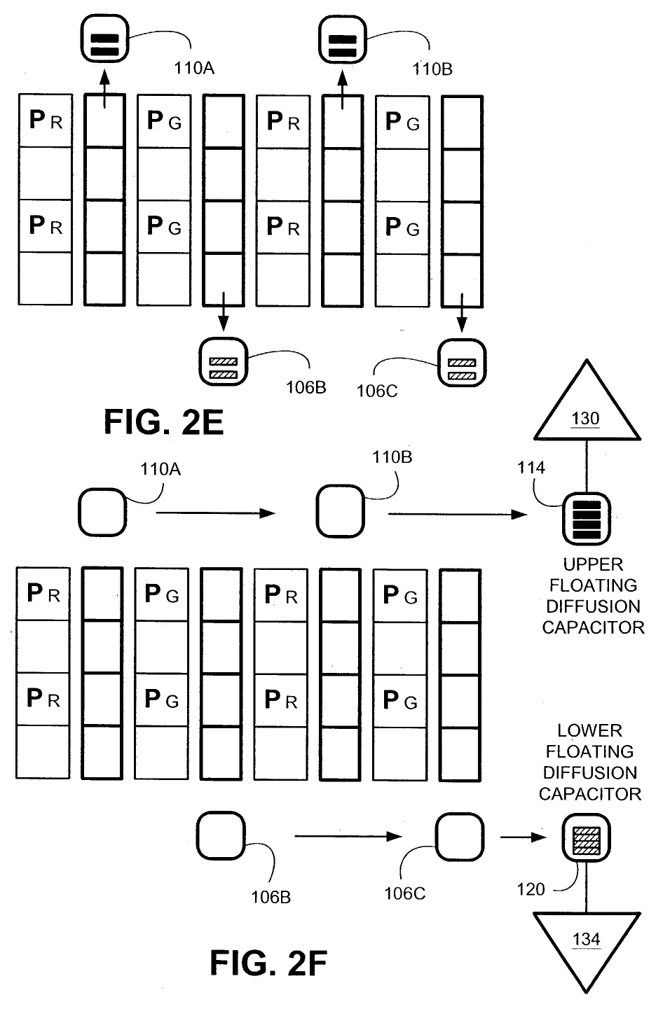

FIGS. 2A-2F are block diagrams illustrating a first communication process employed by an embodiment to communicate red and green light information from selected pixels from a portion of CCD 100 (FIGS. 1A and 1B) according to the present invention. Accordingly, light information corresponding to charges accumulated by the red pixels (PR) and light information corresponding to charges accumulated by a portion of the green pixels (PG) are concurrently communicated via a first path and a second path, respectively.

In FIG. 2A, charges accumulated by the red pixels (PR) are symbolically denoted with a solid-black bar. Similarly, charges accumulated by the green pixels (PG) are symbolically denoted with a diagonally-lined bar. Shift registers R1,1 through R1,4 and R3,1 through R3,4 are empty. That is, shift registers R1,1 through R1,4 and shift registers R3,1 through R3,4 initially do not contain any light information.

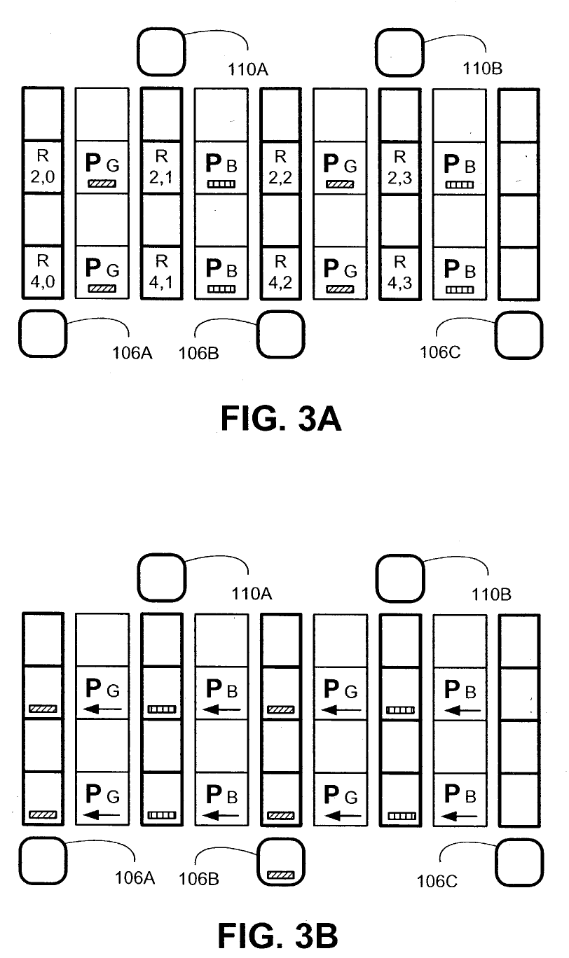

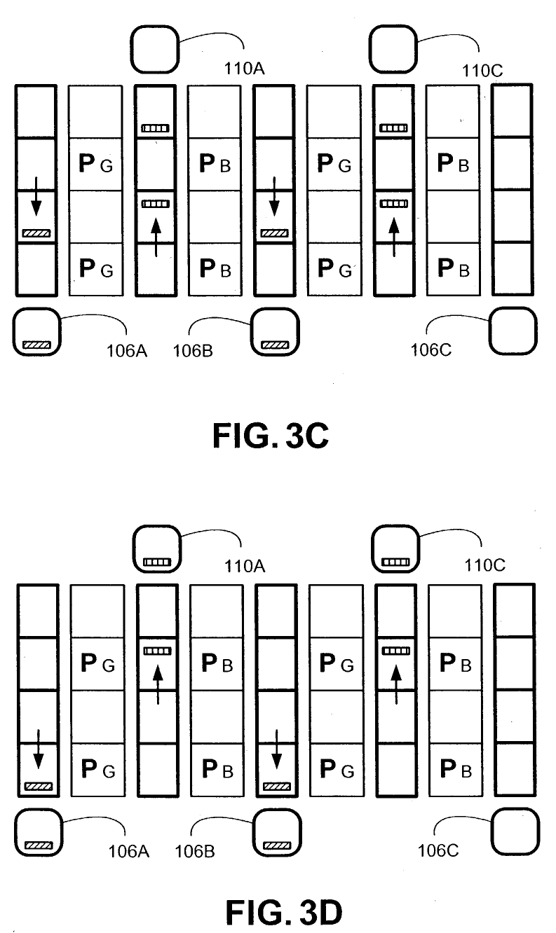

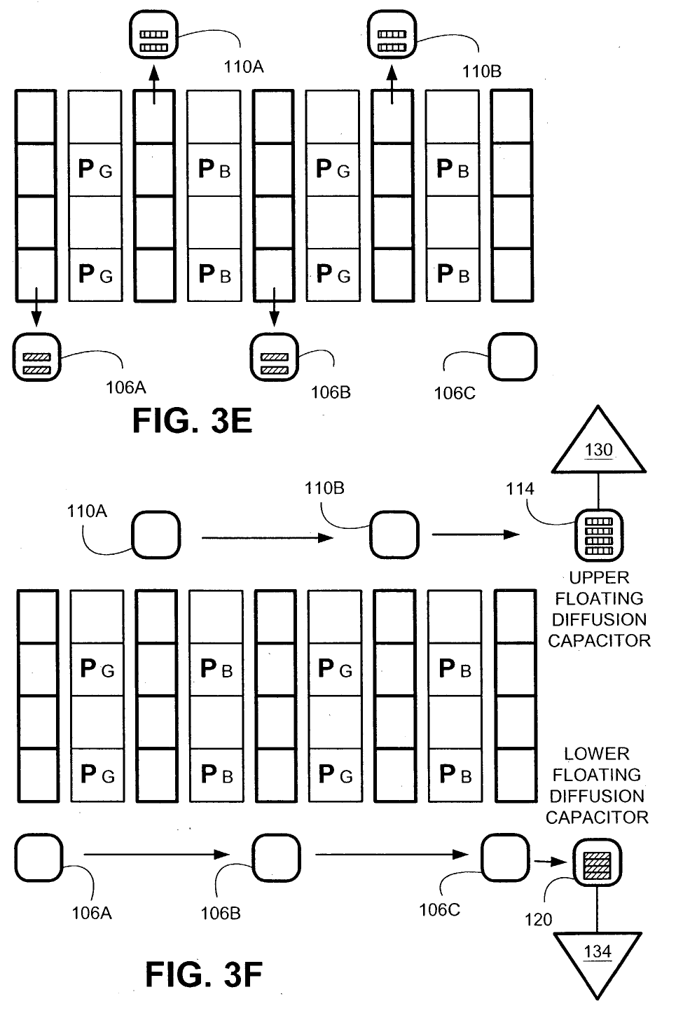

Furthermore, the other pixels of FIG. 2A, illustrated by empty boxes, may have accumulated charge corresponding to light information. Also, their corresponding registers are initially empty. During the process of communicating light information illustrated in FIGS. 2A-2F, any changes residing in the pixels illustrated as empty boxes remain in that pixel during the communication of light information as illustrated in FIGS. 2A-2F. Light information from those pixels is communicated at a later time (see FIGS. 3A-3F).

Upon receiving a suitable clocking signal from control processor 104 (FIG. 1B), the shift registers R1,1 through R1,4 and R3,1 through R3,4 accept light information from the pixel that they are coupled. This communication of light information is graphically illustrated in FIG. 2B. Arrows denote the paths of movement of the communicated light information. In one embodiment of a CCD 100 according to the present invention, charges are communicated into their respective registers.

Another clock signal causes the shift registers to serially communicate the light information by one shift register, as illustrated in FIG. 2C. Accordingly, red light information from the red pixels (PR) is communicated in a first path (upward) by one register and green light information from the green pixels (PG) is communicated in a second path (downward) by one register. If red light information is located in the top-most shift register in a column of shift registers, the clocking signal causes the red light information to be shifted up into the respective shift register in the upper horizontal row of shift registers. Similarly, if green light information is located in the bottom-most shift register in a column of shift registers, the clocking signal causes the green light information to be shifted down into the respective shift register in the lower horizontal row of shift registers. Thus, red light information is communicated into the respective shift registers 110A and 110B (see also FIG. 1B) in the upper horizontal row of shift registers.

Another clock signal causes the shift registers to serially communicate the light information by one shift register, as illustrated in FIG. 2D. Accordingly, red light information is communicated in an upward direction by one register and green light information is communicated in a downward direction by one register. Green light information is communicated into the respective shift registers 106B and 106C (see also FIG. 1B) in the lower horizontal row of shift registers. As illustrated in FIG. 2D, the upper horizontal row of shift registers 110A and 110B have not accumulated any additional light information.

Another clock signal causes the shift registers to again serially communicate the light information by one shift register. Accordingly, the red light information is moved up into the respective shift registers 110A and 110B in the upper horizontal row of shift registers. The green light information moves down one shift register position.

Another clock signal causes the shift registers to once again serially communicate the light information by one shift register. Accordingly, the green light information is moved down into the respective shift registers 106B and 106C in the lower horizontal row of shift registers. As illustrated in FIG. 2E, the shift registers 110A and 110B in the upper horizontal row have now accumulated light information corresponding to charges accumulated by two red pixels (PR). Similarly, the shift registers 106B and 106C in the lower horizontal row have now accumulated light information corresponding to charges accumulated by two green pixels (PG). This accumulation of light information into the shift register residing in the upper or lower horizontal shift register rows is referred to as pixel merging or pixel binning. Since the horizontal shift registers accumulate light information from its respective column of serially-connected shift registers, the horizontal shift registers 110A, 110B, 106B and 106C are preferably accumulating registers.

Another clock signal causes the accumulated red light information in the registers 110A and 110B to be serially communicated to the right by one position. Thus, the accumulated red light information in register 110B is communicated into the upper floating diffusion capacitor 114, and the accumulated red light information in register 110A is communicated into register 110B. Similarly, the accumulated green light information in the registers 106B and 106C are serially communicated to the right by one position. Thus, the accumulated green light information in register 106B is communicated into the register 106C, and the accumulated green light information in register 106C is communicated into the lower floating diffusion capacitor 120.

Another clock signal causes the accumulated red light information in the register 110B to be serially communicated to the right by one position. Thus, the accumulated red light information in register 110B is communicated into the upper floating diffusion capacitor 114, thereby accumulating red light information from four red pixels (PR) into the upper floating diffusion capacitor 114. Similarly, accumulated green light information in register 106C is communicated into the lower floating diffusion capacitor 120, thereby accumulating green light information from four green pixels (PG) into the lower floating diffusion capacitor 120 The accumulated red and green light information in the floating diffusion capacitors 114 and 120, respectively, is illustrated in FIG. 2F.

Once the red light information is accumulated in the upper floating diffusion capacitor 114 and the green light is accumulated in the lower floating diffusion capacitor 120, a clocking signal causes the light information in capacitor 114 and capacitor 120 to be communicated to the upper output amplifier 130 and to the lower output amplifier 134, respectively. Accordingly, the accumulated red light and the accumulated green light information is communicated out to other components residing in the image capture device for further processing.

FIGS. 3A-3F are block diagrams illustrating a second communication process employed by an embodiment for communicating blue and green light information from selected pixels from a portion of CCD 100 according to the present invention. Preferably, the second communication process occurs after the first communication process illustrated by FIGS. 2A-2F. Accordingly, light information corresponding to charges accumulated by the blue pixels (PB) and light information corresponding to charges accumulated by the remaining portion of the green pixels (PG) are concurrently communicated via the first path and the second path, respectively.

In FIG. 3A, charges accumulated by the blue pixels (PB) are symbolically denoted with a vertical-lined bar. Similarly, charges accumulated by the green pixels (PG) are symbolically denoted with a diagonally-lined bar. Shift registers R2,0 through R2,3 and R4,0 through R4,3 in this FIG. 3A are initially empty, i.e., shift registers R2,0 through R2,3 and shift registers R4,0 through R4,3 do not contain any light information.

Upon receiving a suitable clocking signal from control processor 104 (FIG. 1B), the shift registers R2,0 through R2,3 and R4,0 through R4,3 accept light information from the pixel to which they are coupled. This communication of light information is illustrated graphically in FIG. 3B. Arrows denote the path of movement of the communicated light information. In one embodiment of a CCD 100 according to the present invention, charges are communicated into the registers.

Another clock signal causes the shift registers to serially communicate the light information by one shift register, as illustrated in FIG. 3C. Accordingly, blue light information from the blue pixels (PB) is communicated in a first path (upward) by one register and green light information from the green pixels (PG) is communicated in a second path (downward) by one register. If blue light information is located in the top-most shift register in a column of shift registers, the clocking signal causes the blue light information to be shifted up into the respective shift register in the upper horizontal row of shift registers. Similarly, if green light information is located in the bottom-most shift register in a column of shift registers, the clocking signal causes the green light information to be shifted down into the respective shift register in the lower horizontal row of shift registers. Thus, green light information is communicated into the respective shift registers 106A and 106B (see also FIG. 1B) in the lower horizontal row of shift registers.

Another clock signal causes the shift registers to again serially communication the light information by one shift register, as illustrated in FIG. 3D. Accordingly, blue light information is communicated in an upward direction by one register and green light information is communicated in a downward direction by one register. Thus, blue light information is communicated into the respective shift registers 110A and 110B (see also FIG. 1B) in the upper horizontal row of shift registers. As illustrated in FIG. 3D, the lower horizontal row of shift registers 106A or 106B have not accumulated any additional light information.

Another clock signal causes the shift registers to once again serially communicate the light information by one shift register. Accordingly, the green light information is moved down into the respective shift registers 106A and 106B in the lower horizontal row of shift registers. The blue light information moves up one shift register position.

Another clock signal causes the shift registers to serially communicate the light information by one shift register. Accordingly, the blue light information is moved up into the respective shift registers 110A and 110B in the upper horizontal row of shift registers. As illustrated in FIG. 3E, the shift registers 110A and 110B in the upper horizontal row have now accumulated light information corresponding to charges accumulated by two blue pixels (PB). Similarly, the shift registers 106A and 106B in the lower horizontal row have now accumulated light information corresponding to charges accumulated by two green pixels (PG).

Another clock signal causes the accumulated blue light information in the registers 110A and 110B to be serially communicated to the right by one position. Thus, the accumulated blue light information in register 110B is communicated into the upper floating diffusion capacitor 114, and the accumulated blue light information in register 110A is communicated into register 110B. Similarly, the accumulated green light information in the registers 106A and 106B are serially communicated to the right by one position. Thus, the accumulated green light information in register 106A is communicated into register 106B, and the accumulated green light information in register 106B is communicated into register 106C.

Another clock signal causes the accumulated blue light information in the register to be serially communicated to the right by one position. Thus, the accumulated blue light information in register 110B is communicated into the upper floating diffusion capacitor 114, thereby accumulating blue light information from four blue pixels (PB) into the upper floating diffusion capacitor 114. Similarly, accumulated green light information in register 106C is communicated into the lower floating diffusion capacitor 120, thereby accumulating green light information from two green pixels (PG) into the lower floating diffusion capacitor 120, and accumulated green light information in register 106B is communicated into register 106C. Another clock signal communicates the accumulated green light information in register 106C into the lower floating diffusion capacitor 120, thereby accumulating green light information from four green pixels (PG) into the lower floating diffusion capacitor 120. The accumulated blue and green light information in the floating diffusion capacitors 114 and 120, respectively, is illustrated in FIG. 3F.

Once the blue light information is accumulated in the upper floating diffusion capacitor 114 and the green light is accumulated in the lower floating diffusion capacitor 120, a clocking signal causes the light information in capacitor 114 and capacitor 120 to be communicated to the upper output amplifier 130 and to the lower output amplifier 134, respectively. Accordingly, the accumulated blue light information and the accumulated green light information is communicated out to other components residing in the image capture device for further processing.

Upon the completion of accumulation of the red, blue and green light information in the diffusion capacitors 130 and 134, and the subsequent communication of the red, blue and green light information out into the image capture device, the light information from the sixteen individual pixels of FIG. 1B has been converted into a virtual pixel, also referred to as a super pixel. That is, the actual light information detected by the sixteen pixels are aggregated by color into the horizontal row shift registers, thereby creating a virtual pixel of the area covered by the sixteen individual pixels. The above-described process has not averaged light between similarly colored pixels, nor has color information from any pixel been discarded.

The above-described embodiment communicates the accumulated green light information from the lower diffusion capacitor 120 out to the lower output amplifier 134 each time the red light information and each time the blue light information are communicated from the upper diffusion capacitor 114 out to the upper output amplifier 130. That is, half of the green light information is communicated concurrently with the red light information and the other half of the green light is communicated concurrently with the blue light information.

The above-described process of communicating light information from the sixteen pixels, and the aggregation of the light information according to color, is equally applicable to any predefined region of a matrix or area CCD 100. For example, a higher resolution image may be determined by accumulating light information from only four pixels. Alternatively, a lower resolution image may be created by accumulating light information from sixty-four pixels. Furthermore, for convenience, the shape of the region occupied by the sixteen pixels of FIG. 1B is illustrated as an apparent square of pixels. The predefined region of a matrix CCD, or an area CCD, may be defined as any suitable shape, such as, but not limited to, a rectangle. That is, a binning of M×N pixels may be specified by the control processor 104. There are no intended limitations herein to the number of pixels, the size of the predefined region of the matrix, or the shape of the predefined region of the matrix when light information is communicated and aggregated in accordance with the present invention.

When the present invention is implemented in a matrix CCD 100 having a relatively large number of pixels, the pixels are grouped and processed by the control processor into predefined areas of pixels that comprise virtual pixels. Since the red/blue light information is ultimately communicated along a first path and the green light information is communicated along a second path according to the present invention, an image capture device having three million pixels in a matrix CCD can quickly process the light information.

Furthermore, the control processor 104 can define a resolution for the captured image by specifying the number of pixels in a virtual pixel, and by specifying the shape of the grouped pixels. For example, but not limited to, an image capture device having three million pixels, by defining a virtual pixel to have sixteen pixels as shown in FIG. 1B, can reproduce and/or save an image with a resolution of 187,500 virtual pixels (three million divided by sixteen). Accordingly, only 187,500 data values must be stored in a memory if the captured image is to be saved. Furthermore, if less resolution is acceptable and if more images are to be saved into a memory of limited capacity, the control processor 104 may process the three million pixels by groups of sixty-four pixels, thereby generating an image with a resolution of 46,875 virtual pixels. Accordingly, only 46,875 data values must be stored in the memory if the captured image is to be saved. Thus, control processor 104 can more efficiently utilize memory capacity by defining any suitable size virtual pixel.

When the image capture device is processing light information from a relatively large number of pixels to generate video images, the time allotted between image frames is limited. The present invention provides for the accumulation of light information into a manageable number of virtual pixels having a high degree of accuracy, thus avoiding the problems of artifacts and/or artificial color non-uniformity because light information is discarded (as with sampling) or averaged.

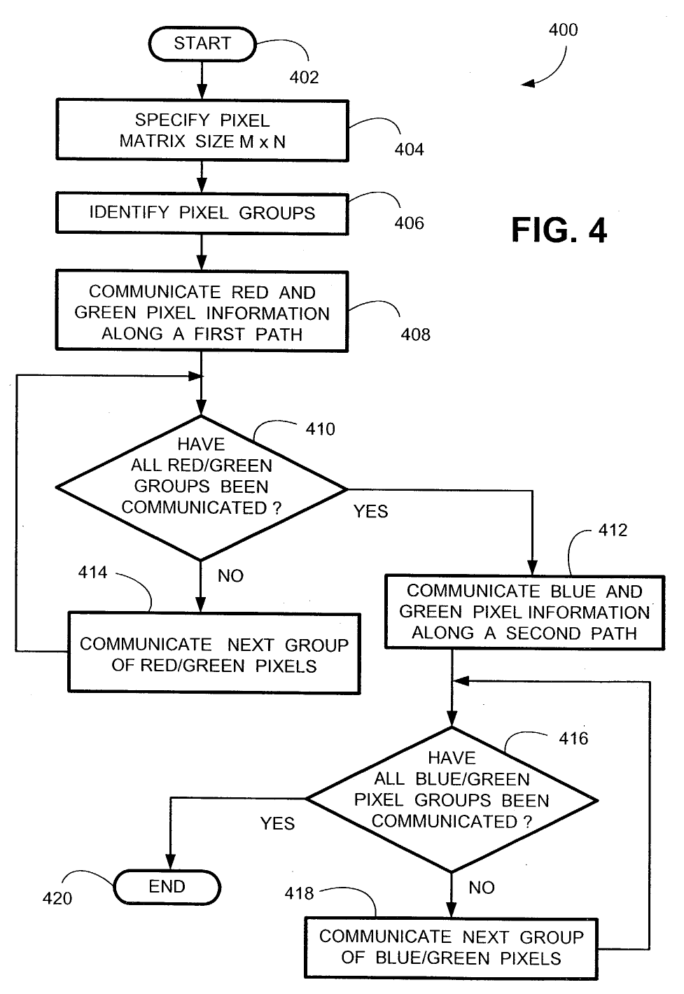

FIG. 4 is a flow chart 400 illustrating an embodiment of a process, according to the present invention, for communicating light information. The flow chart 400 shows the architecture, functionality, and operation of a possible embodiment of software for implementing the logic 138 (FIG. 1B) such that clocking signals communicated by control processor 104 are determined so that color information is communicated through the CCD 100 as described above. In this regard, each block may represent a module, segment or portion of code, which comprises one or more executable instructions for implementing the specified logical function(s). It should also be noted that in some alternative implementations, the functions noted in the blocks may occur out of the order noted in FIG. 4, or may include additional functions without departing from the functionality of the flow chart 400. For example, two blocks shown in succession in FIG. 4 may in fact be executed substantially concurrently, the blocks may sometimes be executed out-of-order, or some of the blocks may not be executed in all instances, depending upon the functionality involved, as will be further clarified hereinbelow. All such modifications and variations are intended to be included herein within the scope of the present invention. Another embodiment employs the logic of flow chart 400 as firmware implemented as a state machine.

The process begins at block 402. At block 404 a pixel matrix size (M×N) is specified. For example, but not limited to, a pixel matrix size of 4×4 as illustrated in FIG. 1B may be specified. At block 406 a plurality of pixel groups, each pixel group sized according to the specified M×N pixel matrix size, are identified. In the above-described example of the image capture device having three million pixels, preferably having 187,500 virtual or super pixels (three million divided by sixteen pixels per group) per the teachings of the present invention, the location of each one of the 187,500 pixel groups are identified.

At block 408, red light information and a portion of the green light information from a first group of pixels is communicated along a first path according to the present invention. Communicating the light information is referred to herein as the process of communicating light information from register to register, and ultimately to the amplifiers 130 and 134, as described above in accordance with the present invention.

At block 410 a determination is made whether all red/green pixel groups have been communicated. If so (the YES condition), the process proceeds to block 412. If other red/green pixel groups are to be communicated (the NO condition), the process proceeds to block 414 where the next group of red/green pixels is communicated along a first path. The process then returns to block 410. This above-described logic loop is repeated until all red/green pixel groups have been communicated.

At block 412, blue light information and the remaining portion of the green light information from the first group of pixels (from which the red/green light information has already been communicated in accordance with the present invention) is communicated along a second path. At block 416 a determination is made whether all blue/green pixel groups have been communicated. If not (the NO condition), the process proceeds to block 418 where the next group of blue/green pixels is communicated. The process returns to block 416. If all of the blue/green pixel groups have been communicated (the NO condition), the process proceeds to block 420 and ends.

In another embodiment, light information from the blue/green pixel groups are communicated first. After the blue/green pixel groups have been communicated, light information from the red/green pixel groups are communicated.

Various orientations of the communication paths may be implemented in alternative embodiments so long as light information from the red pixels (PR) and the blue pixels (PB) is communicated along one path to a first row of shift registers in communication with a floating diffusion capacitor and output amplifier, and light information from the green pixels (PG) is communicated along another path to a second row of shift registers in communication with another floating diffusion capacitor and another output amplifier. For example, light information from the red pixels (PR) and the blue pixels (PB) may be communicated in a downward direction to a lower horizontal row of shift registers, and light information from the green pixels (PG) is communicated in a upward direction to an upper horizontal row of shift registers.

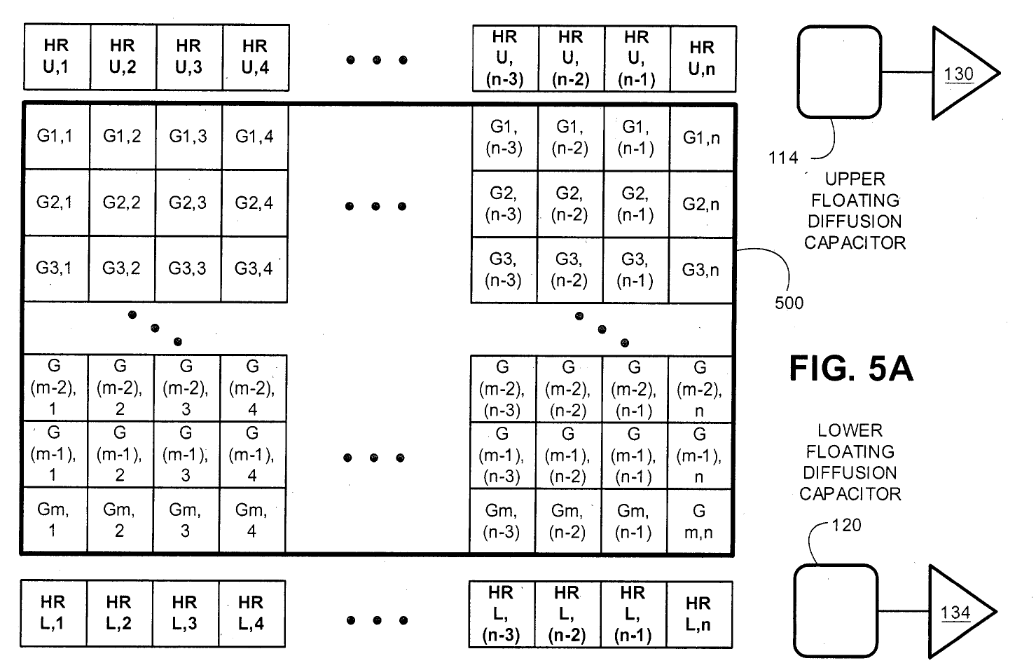

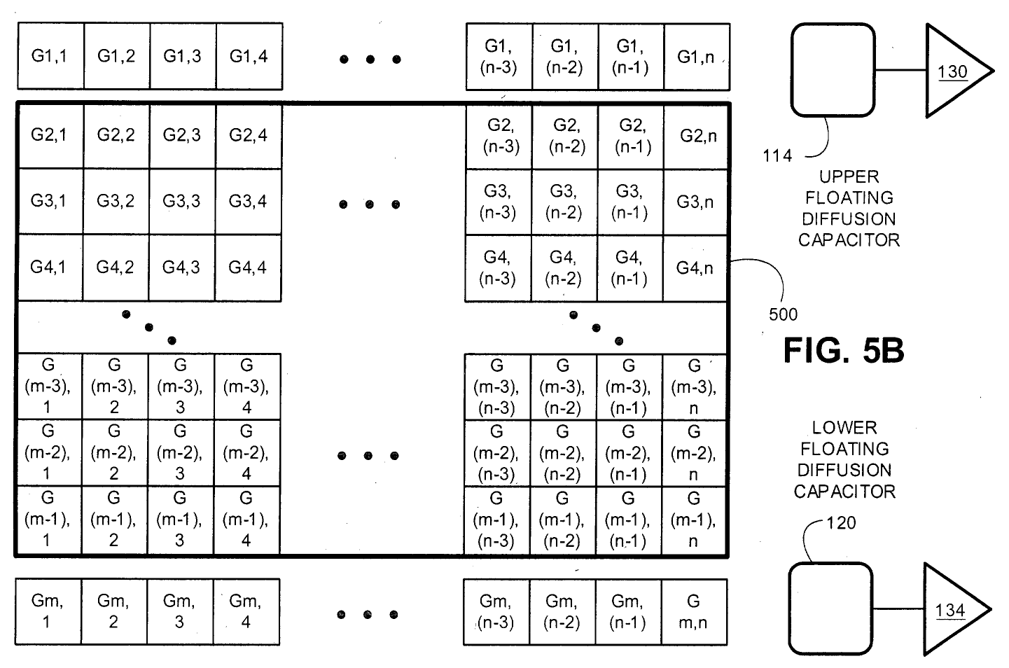

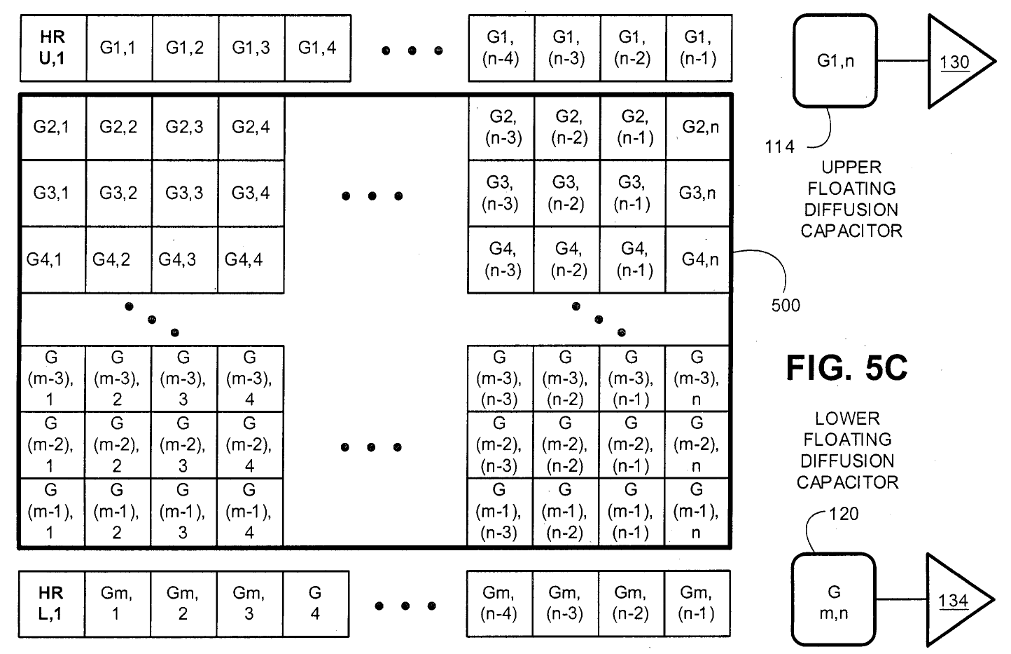

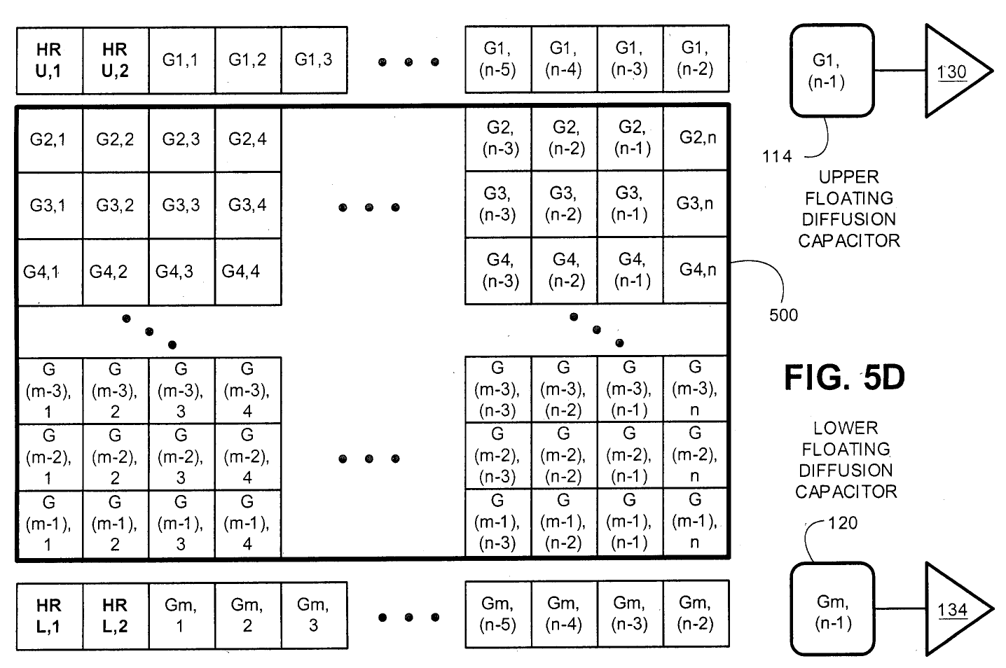

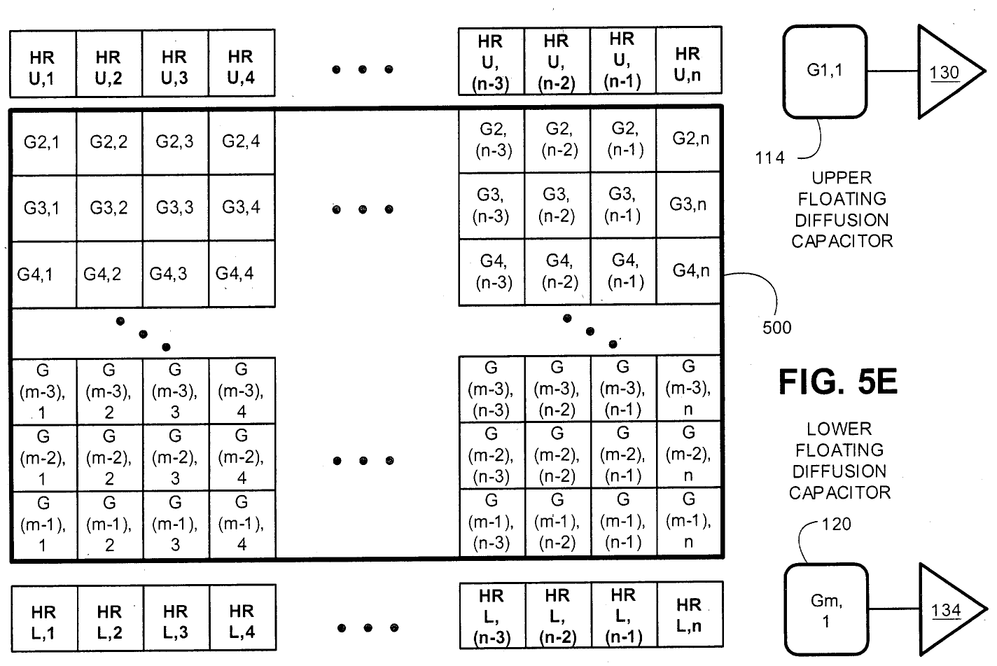

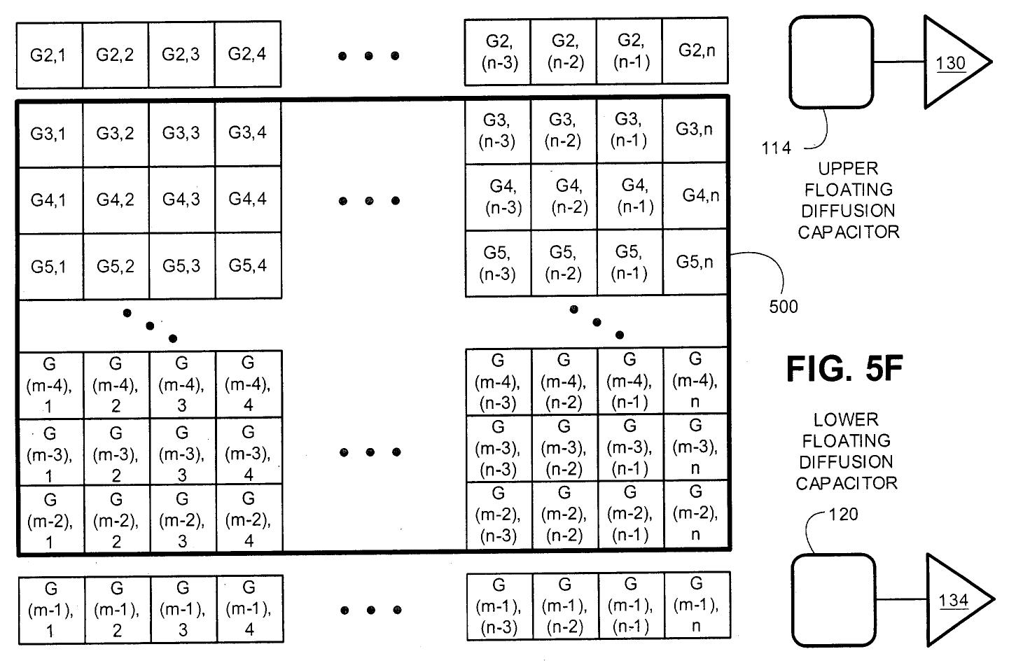

FIGS. 5A-5F are block diagrams illustrating communication of light information from a CCD 500 according to the present invention. CCD 500 corresponds to a matrix of pixels. CCD 500 is divided into a plurality of predefined groups of pixels. For example, but not limited to, sixteen pixels such as the pixel group illustrated in FIG. 1B, FIGS. 2A-2F and 3A-3F, could be defined as a virtual pixel or a super pixel. Thus, each group of pixels in such an example in the CCD 500 is comprised of sixteen pixels. Any suitable number of pixels could be selected as a group, depending upon the desired resolution for the captured image being detected by CCD 500. For example, the exemplary group of pixels identified by the matrix position identifier “(G 1,1)” is located in the upper-most left hand corner of CCD 500. Similarly, the location of any pixels group is identified by a similar matrix position identifier or another suitable position identifier. Thus, the exemplary pixel group designated as (G 3,n) is understood to be located at the third row of pixel groups and the last column.

Also illustrated for convenience in FIGS. 5A-5F are the upper and lower horizontal rows of serial registers. For convenience, one horizontal register group represents a group of horizontal registers corresponding to a predefined pixel group. Thus, if a predefined pixel group corresponds to the sixteen pixels illustrated in FIG. 1B, then the upper and lower horizontal register groups include each two registers. For example, if the pixel group (G 1,1) corresponds to the sixteen pixels of FIG. 1B, then the horizontal register group designated “(HR U,1)” corresponds to the registers 110a and 110b when red/green light is being processed. (where “HR” designates at least one horizontal register, “U” designates the upper row, and “1” designates a relative position of the corresponding pixel group in the CCD 500.) Similarly, the horizontal register group designated “(HR L,1)” corresponds to the registers 106a and 106b when red/green light is being processed. (“HR” designates at least one horizontal register, “L” designates the lower row, and “1” designates a relative position of the corresponding pixel group in the CCD 500.) For convenience, the horizontal register groups are identified in the FIGS. 5A-5F by bold-face font to indicate that the horizontal register group is empty. As described below, when light information is transferred into a horizontal register group, the pixel group identifier is used for convenience so that it is understood the light information from any particular pixel group can be followed during processing of the light information.

FIG. 5A illustrates the condition of the CCD 500 after CCD 500 has been exposed to the light of an image. Thus, each pixel group has red, blue and green light information. The horizontal register groups (HR U,1) through (HR U,n) and the horizontal register groups (HR L, 1) through (HR L,n) are understood to be initially empty (no light information). Also, the floating diffusion capacitors 114 and 120 are initially empty.

FIG. 5B illustrates the communication of red (or blue) light information in an first path (upward direction) into the upper horizontal register groups, and the communication of green light information in a second path (downward direction) into the lower horizontal register groups. Thus, red (or blue) light information from the pixel group (G 1,1) is communicated up into the block of horizontal register group (HR U,1) along a first path. Similarly, red (or blue) light information from each of the other pixel groups of the top row of pixel groups is communicated upward into their corresponding upper horizontal register group. Also, green light information from the pixel group (G m,1) is communicated down along a second path into the horizontal register group (HR L,1). Similarly, green light information from each of the other pixel groups of the bottom row of pixel groups is communicated downward into their corresponding lower horizontal register group.

For example, if a pixel group is defined to have sixteen pixels as in FIG. 1, then the horizontal register group (HR U,1) having light information from the pixel group (G 1,1) in accordance with the present invention and illustrated in FIG. 5B corresponds to the aggregation of light information starting with FIG. 2A and ending with FIG. 2E when red/green light is collected, and corresponds to the aggregation of light information starting with FIG. 3A and ending with FIG. 3E when blue/green light is collected. Thus, in the example illustrated, at least four clocking cycles have transpired during which light information as illustrated in FIG. 5A is communicated as light information illustrated in FIG. 5B.

Next, the light information in the horizontal register groups are communicated to the floating diffusion capacitors 114 and 120, and to the amplifiers 130 and 134. Thus, FIG. 5C illustrates communication of light information in the horizontal register groups to the right by one register group position. Accordingly, the light information for the pixel group (G 1,n) now resides in the upper floating diffusion capacitor 114 and the light information for the pixel group (G m,n) now resides in the lower floating diffusion capacitor 120.

For example, if a pixel group is defined to have sixteen pixels as in FIG. 1, the communication of light information illustrated by FIGS. 5B and 5C corresponds to the communication of light information starting with FIG. 2E and ending with FIG. 2F when red/green light is collected, and corresponds to the aggregation of light information starting with FIG. 3E and ending with FIG. 3F when blue/green light is collected. Thus, in the example illustrated, at least two clocking cycles have transpired during which light information as illustrated in FIG. 5B is communicated as light information illustrated in FIG. 5C.

Next, the light information residing in the floating diffusion capacitors 114 and 120 is communicated to the amplifiers 130 and 134, respectively. Also, light information in the horizontal register groups is communicated to the right by one register group position. Thus, FIG. 5D illustrates the aggregated light information from the pixel group [G 1,(n−1)] residing in the upper floating diffusion capacitor 114 and the aggregated light information from the pixel group [G m,(n−1)] residing in the lower floating diffusion capacitor 120.

The process of communicating light information from the floating diffusion capacitors 114 and 120 to the amplifiers 130 and 134, respectively is repeated until the last of the light information has been communicated out of the horizontal register groups. This situation is illustrated in FIG. 5E. Thus, the aggregated light information collected by the pixel group (G 1,1) is residing in the upper floating diffusion capacitor 114 and the aggregated light information collected by the pixel group (G m,1) is residing in the lower floating diffusion capacitor 120.

The aggregated light information collected by the pixel group (G 1,1) residing in the upper floating diffusion capacitor 114 and the aggregated light information collected by the pixel group (G m,1) residing in the lower floating diffusion capacitor 120 is then communicated to the amplifiers 130 and 134, respectively. Following a suitable number of clocking cycles, the light information from the next pixel groups are communicated into their respective horizontal register groups, as illustrated in FIG. 5F. Thus, the light information from the pixel group (G 2,1) is aggregated into the horizontal register group (HR U,1) and the light information from the pixel group (G m−1) is aggregated into the horizontal register group (HR L,1). Light information residing in the horizontal register groups is communicated, as described above, to the upper floating diffusion capacitor 114 and amplifier 130, and to the lower floating diffusion capacitor 120 and amplifier 134. Eventually, all of the red/green light information is communicated out of the CCD 500. The above-described process is repeated to communicate the blue/green light out of the CCD 500.

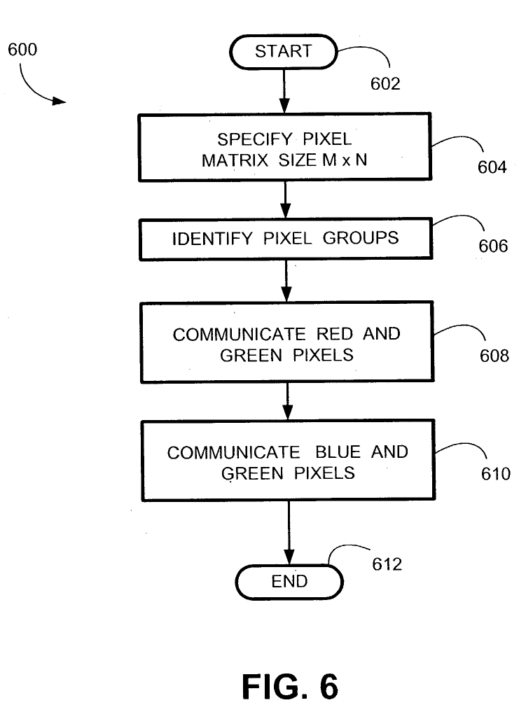

FIG. 6 is a flow chart 600 illustrating a process, according to the present invention, for communicating light information. The flow chart 600 shows the architecture, functionality, and operation of another possible embodiment of software for implementing the logic 138 (FIG. 1B) such that clocking signals communicated by control processor 104 are determined so that color information is communicated through the CCD 500 as described above in accordance with the present invention. In this regard, each block may represent a module, segment or portion of code, which comprises one or more executable instructions for implementing the specified logical function(s). It should also be noted that in some alternative implementations, the functions noted in the blocks may occur out of the order noted in FIG. 6, or may include additional functions without departing from the functionality of the flow chart 600. For example, two blocks shown in succession in FIG. 6 may in fact be executed substantially concurrently, the blocks may sometimes be executed out-of-order, or some of the blocks may not be executed in all instances, depending upon the functionality involved, as will be further clarified hereinbelow. All such modifications and variations are intended to be included herein within the scope of the present invention.

The process begins at block 602. At block 604 a pixel matrix size (M×N) is specified. For example, but not limited to, the pixel matrix size of 4×4 is illustrated in FIG. 1B may be specified. In accordance with the present invention, any suitable pixel matrix size is specified based upon the desired resolution of the captured image.

At block 606 a plurality of pixel groups, each pixel group sized according to the specified M×N pixel matrix size, are determined. Thus a pixel group is defined, such as the exemplary pixel group (G 1,1) of FIGS. 5A-5F. In the above-described example of the image capture device having three million pixels, defined as having 187,500 virtual pixels (three million divided by sixteen pixels per group), the location of each one of the 187,500 virtual pixels is defined.

At block 608, red and green light information from all groups of pixels is communicated from CCD 500 according to the present invention. At block 610, blue and green light information from CCD 500 is communicated according to the present invention. Another embodiment of the present invention communicates the blue/green light information first, and then communicates the red/green light information. The process ends at block 612.

Embodiments of logic 138 implemented in a memory using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

What is claimed:

1. A method for communicating information within an image capture device, the method comprising:
communicating information from a first plurality of pixels sensitive to a first color of light along a first path, and concurrently communicating information from a portion of a second plurality of pixels sensitive to a second color of light along a second path; and
communicating information from a third plurality of pixels sensitive to a third color of light along the first path, and concurrently communicating information from a remaining portion of the second plurality of pixels sensitive to the second color of light along the second path.

2. The method of claim 1, further comprising specifying a pixel matrix size.

3. The method of claim 2, further comprising identifying a plurality of pixel groups based upon the specified pixel matrix size.

4. The method of claim 1, further comprising sensing green light information with the second plurality of pixels.

5. The method of claim 1, further comprising sensing light information with the second plurality of pixels selected from a group consisting green light, red light and blue light.

6. The method of claim 1, further comprising:
accumulating the information corresponding to the first color of light into a first register and concurrently accumulating the information corresponding to the second color of light from the portion of the second plurality of pixels into a second register;
communicating the information corresponding to the first color of light from the first register to a first amplifier and concurrently communicating the information corresponding to the second color of light from the second register to a second amplifier;
accumulating the information corresponding to the third color of light from the first plurality of pixels into the first register and accumulating the information corresponding to the second color of light from the remaining portion of the second plurality of pixels into the second register; and
communicating the information corresponding to the third color of light from the first register to the first amplifier and communicating the information corresponding to the second color of light from the second register to the second amplifier.

7. The method of claim 1, further comprising:
sensing red light with the first plurality of pixels;
sensing green light with the second plurality of pixels; and
sensing blue light with the third plurality of pixels.

8. The method of claim 7, further comprising:
generating information corresponding to the red light from charge accumulated by at least one of the first plurality of pixels when the red light is sensed;
generating information corresponding to the green light from charge accumulated by at least one of the second plurality of pixels when the green light is sensed; and
generating information corresponding to the blue light from charge accumulated by at least one of the third plurality of pixels when the blue light is sensed.

9. A system that communicates information in an image capture device, comprising:
a pixel matrix comprising:
a first plurality of pixels sensitive to a first color of light,
a second plurality of pixels sensitive to a second color of light, and
a third plurality of pixels sensitive to a third color of light;
a first plurality of serially-connected shift registers configured to communicate information from the first plurality of pixels and the third plurality of pixels; and
a second plurality of serially-connected shift registers configured to communicate information from the second plurality of pixels,
such that the information from the first plurality of pixels is communicated along a first path and the information from a portion of the second plurality of pixels is concurrently communicated along a second path, and
such that the information from the third plurality of pixels is later communicated along the first path and the information from a remaining portion of the second plurality of pixels is later concurrently communicated along the second path.

10. The system of claim 9, further comprising:
a first accumulating register coupled to a last register of the first plurality of shift registers, and configured to accumulate the information from the first plurality of shift registers; and
a second accumulating register coupled to the last register of the second plurality of shift registers, and configured to accumulate the information from the second plurality of shift registers.

11. The system of claim 9, further comprising:
a first amplifier communicatively coupled to a last register of the first plurality of shift registers, and configured to amplify the information corresponding to the first color of light and the third color of light; and
a second amplifier communicatively coupled to a last register of the second plurality of shift registers, and configured to amplify the information corresponding to the second color of light.

12. The system of claim 9, wherein the second plurality of pixels further comprises pixels sensitive to green light.

13. The system of claim 9, wherein the second plurality of pixels further comprises pixels sensitive to light selected from a group consisting green light, red light and blue light.

14. The system of claim 9, further comprising a charge-coupled device (CCD) wherein the first plurality of pixels, the second plurality of pixels and the third plurality of pixels reside.

15. The system of claim 9, further comprising a plurality of pixel matrixes, each of the pixel matrixes having a unique first plurality of pixels, second plurality of pixels and third plurality of pixels such that the information from each of the first plurality of pixels is communicated along the first path and the information from a portion of each of the second plurality of pixels is communicated along the second path, and such that the information from each of the third plurality of pixels is later communicated along the first path and the information from a remaining portion of each of the second plurality of pixels is later communicated along the second path.

16. The system of claim 9, wherein the image capture device comprises at least one selected from a group consisting of a digital camera, a digital video camera, a digital still camera, a copy machine, a facsimile machine and a scanner.

17. A system that communicates information in an image capture device, comprising:
a first path configured to communicate information from a first plurality of pixels sensitive to a first color of light and a second plurality of pixels sensitive to a second color of light; and
a second path configured to communicate information from a third plurality of pixels sensitive to a third color of light,
configured such that the information from the first plurality of pixels and the information from a portion of the third plurality of pixels is communicated during a first communication process, and further configured such that the information from the second plurality of pixels and the information from a remaining portion of the third plurality of pixels is later communicated during a second communication process.

18. The system of claim 17, further comprising a pixel matrix of a specified size, the pixel matrix comprised of the first plurality of pixels, the second plurality of pixels and the third plurality of pixels.

19. The system of claim 17, wherein the first path further comprises a first plurality of serially-connected shift registers and the second path further comprises a second plurality of serially-connected shift registers.

20. The system of claim 17, wherein the first path further comprises a first amplifier configured to amplify information corresponding to the first color of light and the second color of light and wherein the second path further comprises a second amplifier configured to amplify information corresponding to the third color of light.

21. The system of claim 17, wherein the first plurality of pixels further comprises pixels sensitive to red light, wherein the second plurality of pixels further comprises pixels sensitive to blue light, and wherein the third plurality of pixels further comprises pixels sensitive to green light.

22. The system of claim 17, further comprising a charge-coupled device (CCD) wherein the first plurality of pixels, the second plurality of pixels and the third plurality of pixels reside.

23. The system of claim 17, wherein the image capture device comprises at least one selected from a group consisting of a digital camera, a digital video camera, a digital still camera, a copy machine, a facsimile machine and a scanner.

24. A system for communicating information in an image capture device, comprising:
means for communicating information corresponding to a first color of light along a first path;
means for communicating a portion of information corresponding to a second color of light along a second path;
means for later communicating information corresponding to a third color of light along the first path; and
means for later communicating a remaining portion of the information corresponding to the second color of light.

25. The system of claim 24, further comprising:
means for generating the information corresponding to the first color of light;
means for generating the information corresponding to the second color of light; and
means for generating the information corresponding to the third color of light.

26. A computer-readable medium having a program for communicating information in an image capture device, the program comprising logic configured to:
communicate information corresponding to a first color of light along a first path from a first plurality of pixels sensitive to the first color of light, and communicating information corresponding to a second color of light along a second path from a portion of a second plurality of pixels sensitive to the second color of light; and
communicate information corresponding to a third color of light along the first path from a third plurality of pixels sensitive to the third color of light, and communicating information corresponding to the second color of light along the second path from a remaining portion of the second plurality of pixels sensitive to the second color of light.
